(19) United States
(12) Patent Application Publication
(10) Pub. No.: US 2010/0325546 A1
(43) Pub. Date: Dec. 23, 2010

(54) METHOD FOR OPTIMIZING AND PRIORITIZING VIDEO ROUTING OPERATIONS IN CONJUNCTION WITH MULTIPLE INTEGRATED DEVICE CONTROLS IN AN INTEGRATED, CONFIGURABLE OPERATION ROOM SYSTEM

(75) Inventors: Joseph K. LEO, Macungie, PA (US); Douglas J. EBERHART, Easton, PA (US); Nathaniel J. FINGER, Macungie, PA (US); Peter A. CARDILLO, Brooklyn, NY (US); John T. NEDICK, Whitehall, PA (US); Louis J. RUSSO, Bethlehem, PA (US)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS AMERICA INC., Center Valley, PA (US)

(21) Appl. No.: 12/818,804

(22) Filed: Jun. 18, 2010

Related U.S. Application Data
(60) Provisional application No. 61/218,589, filed on Jun. 19, 2009.

(51) Int. Cl. G06F 3/048; G06F 3/01

(52) U.S. Cl. 715/719; 715/810

(57) ABSTRACT

A method to optimize and prioritize video routing operations in conjunction with multiple integrated device controls in an integrated operating room system is presented. The method comprises initializing a routing having a source and a destination for routable devices, displaying the routing and a device menu including routable and non-routable devices, requesting a change in the devices, and for each of the devices for which a change is requested, opening a device control window for the device using the device menu, changing the device according to the change request, and closing the device control window, wherein for every device for which a change is requested, when the device control window is opened, all other devices remain accessible. In one embodiment, displaying is performed using a touch screen. In one embodiment, when a change is requested for a routable device, a small video preview window replaces the normal video preview window.

### CROSS REFERENCE TO RELATED APPLICATIONS

This application claims the benefit of U.S. Provisional Application No. 61/218,589 filed on Jun. 19, 2009, the disclosure of which is incorporated herein by reference in its entirety.

### FIELD OF THE INVENTION

The present invention relates generally to video routing and more particularly to optimizing and prioritizing video routing operations in an integrated Operating Room (OR) system.

### BACKGROUND OF THE INVENTION

Current surgical procedures involve the use of various concurrent imaging systems and devices. Such systems and devices can include endoscopic imaging, laparoscopic imaging, radiological imaging, ultrasound imaging, vital signs, hospital information systems, PACS, standard video, e.g., Video Conference, among others. The multiple concurrent imaging information required for viewing in various surgical procedures is presented to the users (surgeons, nurses, clinicians) through multiple video displays. The routing of each and all of the required video in a manner that is intuitive and simple for the user is critical in ensuring that the required information is presented quickly and accurately without causing any distraction or interruption to the ongoing OR procedure.

Video routing is one feature typically found in integrated OR Systems available in the market today. Such systems generally also provide a host of other integrated features such as observation camera control, video conference control, room light control, music functions, telephony, and video conference functions, among others. When users of such systems are required to operate the non-video routing functions, such as music or room lights, the video routing controls interface screen is removed or replaced by another user interface screen. Under such conditions, the users cannot effectively complete video routing controls without being distracted.

This situation is described in the following use case example employing a known integrated system for a typical laparoscopic procedure. Initially, the integrated system has laparoscope camera video routed to display 1, observation camera video routed on display 2, and MRI image routed on display 3. During the surgical procedure, the surgeon makes the following two consecutive requests: dim the room lights, and route the laparoscope video to display 3. Responding to the surgeon requests, the user, for example the nurse responsible for operating the integration system, proceeds as follows. Initially, the nurse selects room light controls, causing the video routing screen to disappear and the room light control screen to appear. The nurse enters the appropriate command(s) on the room light control screen and the room light is dimmed. Next, the nurse selects video routing control, causing the room light control screen to disappear and the video routing control screen to reappear. Then, the nurse can issue the command to route the laparoscope video to display 3, in accordance with the surgeon's request.

Hence, as shown in this example, the nurse must navigate through multiple different screens to execute the required operations to satisfy the surgeon's request. This multi-step process often results in the nurse's disorientation and affects her ability to execute the video routing request quickly and accurately, which may then cause distraction or interruption of the ongoing surgical procedure. Thus there is a need for simplification of the video routing process during OR procedures.

### SUMMARY OF THE INVENTION

The inventive system enables control of various OR devices all from a single display device such as a touch panel interface, thereby facilitating work flow and improving efficiency. The present invention provides a graphical user interface that retains the ability to perform the critical video routing controls concurrently with control of other, non-video routing devices.

The present invention advantageously provides a system and method to optimize and prioritize video routing operations in conjunction with multiple integrated device controls in an integrated operating room system, having steps of initializing a routing having a source and a destination for one or more routable devices, displaying, on the integrated operating room system, the routing and a device menu including the one or more routable devices and one or more non-routable devices, requesting a change in one or more of the routable devices and the non-routable devices, and for each of the devices for which a change is requested, opening a device control window for the device using the device menu, changing the device in accordance with the change request, and closing the device control window, wherein for every device for which a change is requested, when the device control window is opened, all other routable and non-routable devices remain accessible. In one embodiment, when a change is requested for a routable device, before the device control window for the device is opened, a video preview window is replaced with a small video preview window, and after the device control window is closed, the small video preview window is replaced with a normal video preview window. In one embodiment, displaying on the integrated operating room system is performed using a touch screen. In one embodiment, accessible means visible on the touch screen.

A program storage device readable by a machine, tangibly embodying a program of instructions executable by the machine to perform methods described herein may be also provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic diagram of the inventive system in a typical setting;

FIG. 2 is a touch screen with video preview in accordance with one embodiment of the invention;

FIG. 3 is a touch screen with small video preview in accordance with one embodiment of the invention;

FIG. 4 is a source bank window in accordance with one embodiment of the invention; and

FIG. 5 is a flow diagram of the inventive method.

### DETAILED DESCRIPTION OF THE INVENTION

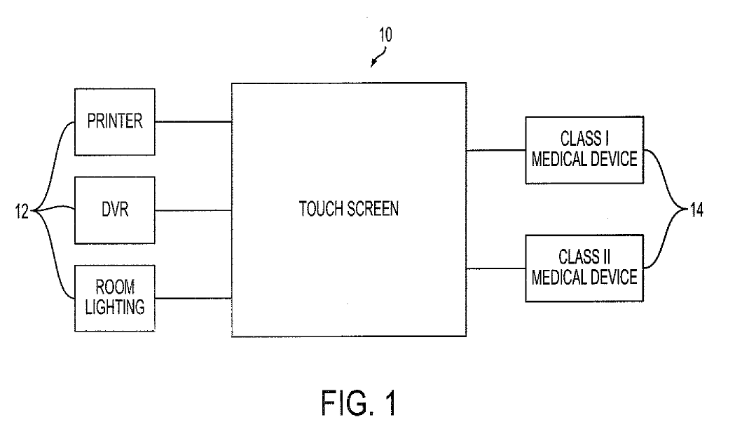

An inventive solution is presented to the need for a system and method to perform the critical video routing controls concurrently under conditions when controls of the other devices are also required. The system is characterized by its ease of use, modularity, and safety features, and is configurable and customizable. FIG. 1 is a schematic diagram of the inventive system in a typical setting. As shown in FIG. 1, a Graphical User Interface (GUI) shall be presented to a user via a touch screen 10, enabling the user to command and control various functions including audio and video routing, communications, and control of various non-medical 12 and medical devices 14 in an OR or operating suite. In one embodiment, the system provides a single touch panel interface 10 that can be shared between a Class I and a Class II medical device 14.

Some of the medical 14 and non-medical 12 devices controllable by the system can include TP interface, video switcher, audio conference, room camera, video conference, medical device control, TP switcher, iPod®, DVR, surgical light, surgical camera, room light, monitor and video printer. Numerous video formats are supported, including HD-SDI, S Video, and RGBHV.

Various features and functions are found in the inventive system, including video routing, HD distribution, Digital Recording Control, HIS routing, PACs Image routing, guest ports, single touch panel control, MP3/CD and iPOD® control, observation camera, audio and video conference, room light control, medical device control via shared touch panel, and secondary touch panel. OR procedures with different requirements are enabled, such as surgical procedures requiring multiple imaging sources, having variable positions of video images for each procedure, having variable types and/or numbers of video sources, and having variable types and/or number of displays from customer to customer. Single touch panel control and external control unit integrations requiring adjustments of various devices and room conditions are a common situation within the OR; single touch panel controls offer improved efficiencies to overall OR workflow.

Digital Recording Control enables documentation of procedure, education and training, presentation, research and study. Because it is common to have background music playing during a procedure in the OR, and because personal music is favored, MP3/CD and iPod® control can be provided. Audio conference and/or video conferencing with wired or wireless microphones enables activities including consultation, mentoring, education and training, and information. Room lighting control enables adjustment of room and/or surgical lighting conditions. Integration of room and/or surgical lighting control on a single touch panel 10 improves workflow efficiencies.

The system can include various subsystems, such as a control subsystem, a video subsystem, and an audio subsystem. The control subsystem can have an embedded controller used for controlling various A/V source and destination equipment in the OR. The video subsystem can have video capturing and signal routing devices, e.g., medical endoscopic subsystems, consumer and professional cameras, distribution amplifiers, and video matrix switchers. The audio subsystem can have amplifiers, speakers, and music devices, e.g., optional MP3/CD player and iPod® devices.

Audio processing device(s) can be controlled by the system to perform the required audio functions for at least each of the following functional requirements: master speaker volume, iPod® control, auxiliary stereo line input audio processing, audio routing, line and microphone inputs setup, audio conferencing, video conferencing, DVR audio recording, and hotline connections.

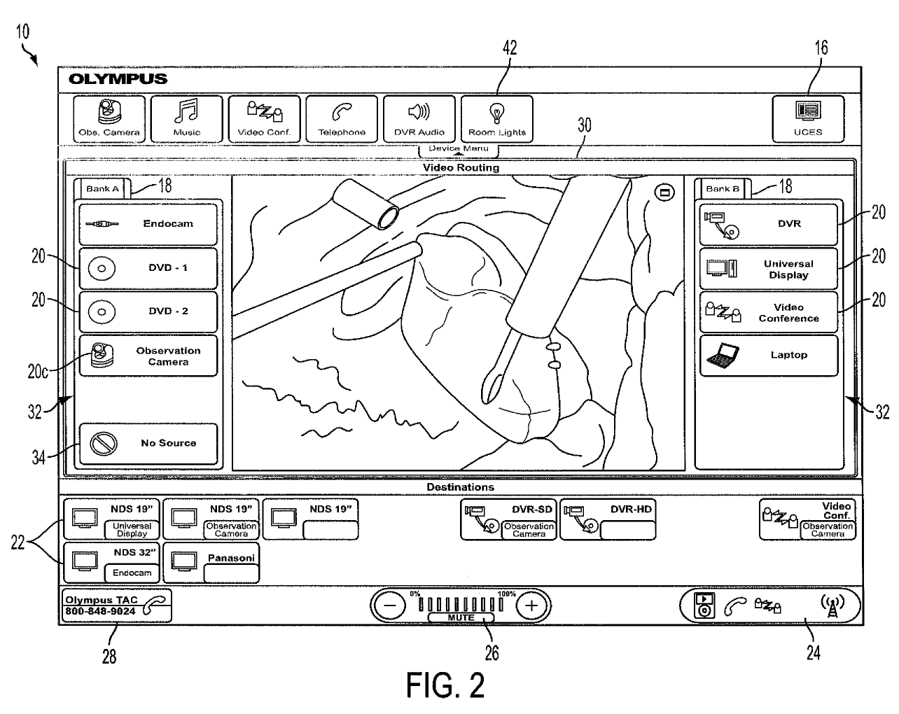

Numerous configurable elements can be included in the system, such as video source buttons, video destination buttons, tab column labels, video conference, room light control, telephone, DVR audio, external medical device(s) shared touch panel, hotline button, observation camera, and music. FIG. 2 illustrates major configurable elements that comprise the Main Page or touch screen 10 of one embodiment of the inventive system, including the Title Bar, Device Menu 16, Device Control Buttons, Video Routing, Video Source Tabs (Bank Selectors) 18, Video Source Buttons 20, Destinations, Video Destination Buttons 22, Supplemental Functions and Status Bar (Notifications) 24, Master Speaker Volume Control 26, Hotline or TAC Button 28, Music and Communications Control. These elements and the associated functional requirements are discussed below. FIG. 2 shows a Video Preview Window 30, that is, alive video window displaying current select video source with the video size normalized and optimized.

The Source Bank Window 32 comprises Bank Selectors or Video Source Tabs 18 and Video Source Buttons 20. In one embodiment, there are two Source Bank Windows 32, each having three Video Source Tabs 18. The two Source Bank Windows can be on either side of the Video Preview Window 30, as shown in FIG. 2. In one embodiment, there can be thirty-six Video Source Buttons 20, that is, six tabs 18 of buttons 20 with six buttons 20 on each tab 18.

Each of the Video Source buttons 20 can be assigned to a video input signal. For example, as shown in FIG. 2, the Observation Camera source can be assigned button 20oc.

Each video input source may have more than one Source button, for example as configured by the Configuration File settings. Buttons 20 not assigned to any video input shall not be visible on the screen 10. A “No Source” button 34, shown in Bank A 18, is discussed below. The text label and the graphical icon displayed on each source button 20 are both customizable, as is the text label displayed on the tab 18. Tabs 18 that do not have any assigned buttons shall not be visible. For example, FIG. 2 shows only one tab (Bank A) 18 on the left side of the Video Preview Window 30 and only one tab (Bank B) 18 on the right side of the Video Preview Window 30.

The Device Menu 16 is a menu with all available controllable devices. This Menu 16 can be hidden by the user for a visually simplified interface. The Device Menu 16 shall be activated by a single command button, which shall toggle from expanded menu window back to single button shown in FIG. 2.

Video Destination Buttons 22 can provide locations of all available destinations. Up to sixteen destination buttons can be present with fully customizable icon graphics and user text. Video outputs are assigned to configurable Video Destination buttons 22 that users select on the Touch Panel 10 for the purpose of video routing. In one embodiment, the Video Destination buttons 22 are arranged as two rows of buttons, up to eight buttons per row, positioned below the Video Preview Window 30. Each Video Destination button 22 can be assigned to one and only one video output destination, such as Display, DVR, and Video Conference. Buttons 22 that are not configured for a video output will not be visible on the touch screen 10. Assigned buttons shall be configured to support all the video formats of the output destination. Both the text label and the graphical icon displayed on each destination button 22 are customizable.

The Notification or Status Bar 24 provides visual feedback for devices such as an iPod®, telephone, video conference and transmission; this status indicator remains visible at all times. Icons can also be shortcut buttons to commonly used functions with those devices. For example, a transmit icon will mute all audio and video being transmitted to telephone and/or video conferencing, if active.

The Master Speaker Volume Control 26 provides program volume control and mute; this button remains visible at all times. The Master Speaker Volume Control 26 is always visible in the center of the Supplemental Functions and Status Bar 24 in the lower portion of the screen. The Master Speaker Volume Control 26 shall control the speaker volume of the most recently selected, “active” Audio Device. In one embodiment, the system shall be capable of controlling the audio processing device listed in the Master Device list via an RS-232 Interface to perform the required Telephone audio conference functions. The call in progress speaker volume control can be specified in the Master Speaker Volume Control 26.

The TAC or Hotline button 28 provides a shortcut button to directly reach the Technical Assistance Center; this button remains visible at all times.

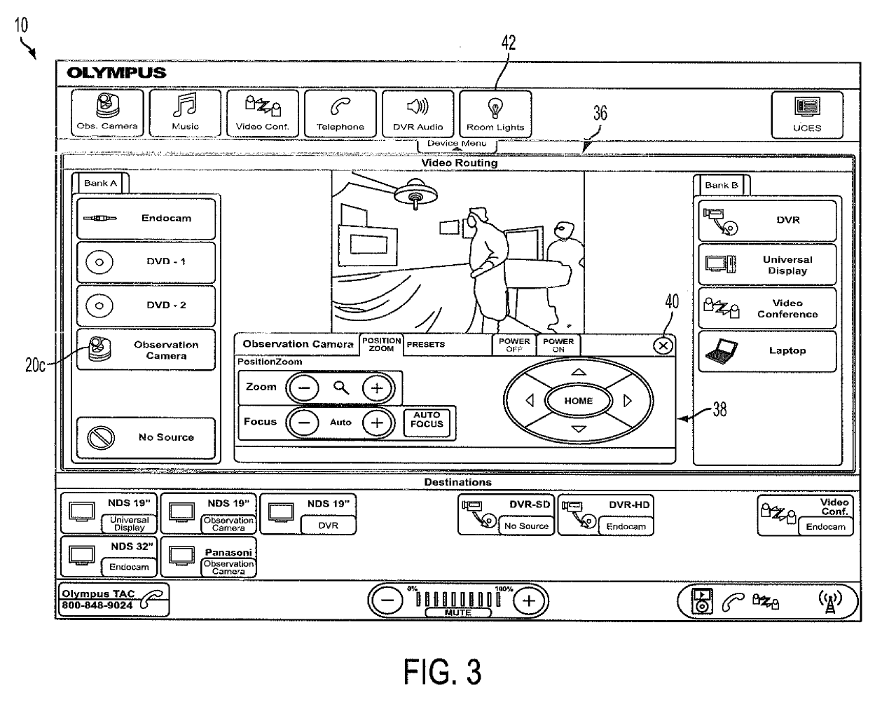

FIG. 3 shows the Small Video Preview Window 36 in the touch screen 10. The Small Video Preview 36 is a live video window displaying current select video source with the video size reduced and optimized for maximum available screen use, enabling video preview even when the Device Menu Window 38 is operational. The Device Menu Window 38 can be a standardized popup window where all device controls for the selected device will appear. Operation of the Device Menu Window 38 does not interfere with normal user operation.

FIG. 3 shows the Device Menu Window for the Observation Camera Control Window 38. This Window 38 shall be opened by selecting the Observation Camera when the Device Control Menu is visible (after toggling Device Menu 16). The video appearing in the Video Preview Window 30, 36 shall continue to display the video source that was last selected. The Observation Camera Source button 20oc must be selected to make the camera video appear in the Video Preview window 36. The Observation Camera Control function is enabled only when the Observation Camera Control window 38 is visible in the Reduced sized Video Preview window 36. Camera control shall not be active in the Normal 30 and Maximized sized windows. The Observation Camera Control Window 38 shall provide an exit button 40 to close the control window to return to the main Video Routing mode and return the Video Preview window to the Normal size.

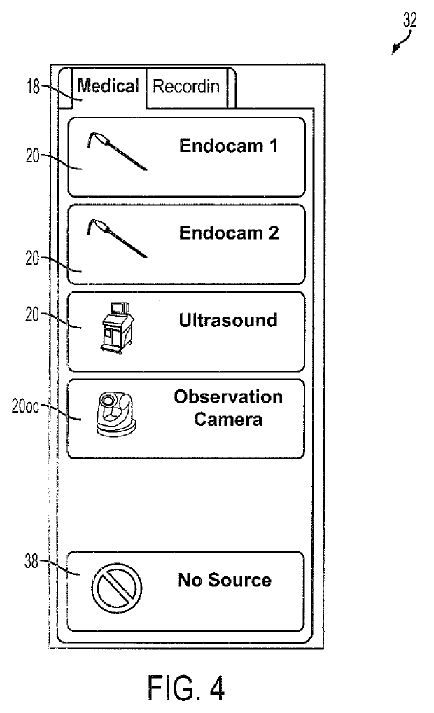

FIG. 4 shows an exemplary Source Bank Window 32 having an active Tab 18 customized with the text “Medical”. Also shown are four configured Video Source buttons 20, 20oc and a No Source button 34.

As indicated above, the Video Preview window 30, 36 shall be presented on the Touch Screen 10 within the video routing page. The Video Preview window 30, 36 shall display the current source video selected. The Preview Window can appear in three sizes: normal 30, maximized (not shown) and reduced 36. The Normal Video Preview 30 appears as a sub-window in the center of the main video routing page 10, as shown in FIG. 2. A button is located on the upper right hand corner to switch to the Video Preview Maximized size. The Maximized Video Preview appears as a full screen, so that the Video Routing page is no longer visible. Maximized Video Preview is activated from a control in Normal or Reduced sized Video Preview. A button is located in the upper right corner of the window to return the Video Preview to originating Video Preview window size (Normal or Reduced). As shown in FIG. 3, the Small or Reduced sized Preview Video window 36 appears as a smaller window over the Device Menu Window or Device Control sub-window 38 whenever a Device Control is activated. A button is located on the upper right hand corner to switch to the Maximized Video Preview mode.

A Video Source can be routed to a destination. The following specifies the sequence of actions and behavior of the GUI to complete the routing of a video source to selected destinations. Select the video source Tab 18 that contains the desired video. If the video source is already visible under the active Tab, it would not be necessary to press the active Tab. Otherwise, select and activate other Tabs, one at a time, until the desired Video Source is visible. When selected, the Video Source button 20 shall be highlighted and remain highlighted until another source is selected. The Destinations that are not compatible with the selected source shall be masked with a gray overlay. Select the desired destination compatible display monitor. No action shall result if a masked destination is selected. The selected video source shall appear on the Video Preview Window 30, 36. The video appearing shall remain in the Preview Window 30, 36 until another video source is selected.

If the selected destination is a display monitor that is compatible with the source video then the customized text from the selected source shall appear in the lower right corner of the Destination button 22 as an indication of the completed route. The selected video, visible in the Preview Window 30, 36 shall appear on the selected display monitor. Additional destinations may be selected.

If the selected destination is a DVR that is compatible with the source video then the customized text from the selected source shall appear in the lower right corner of the Destination button 22 as an indication of the completed route. The selected video, visible in the Preview Window 30, 36 shall also be visible in the DVR recording preview screen. Additional information about the DVR as Video Source is below. Additional destinations may be selected.

If the selected destination is a Video Conference device that is compatible with the source video then the customized text from the selected source shall appear in the lower right corner of the Destination button 22 as an indication of the completed route. The selected video, visible in the Preview Window 30, 36, shall be visible on the Video Conference view of the local video. Additional information about the Video Conference as source is below. Additional destinations may be selected.

The DVR's main screen video is available as a video input in a video format. When the DVR is selected as a source, the DVR's main screen can be viewed on the Preview Window 30, 36. The DVR's main screen can also be routed and viewed on a compatible display monitor. The DVR destination shall be masked. The DVR source video cannot be routed back to the DVR.

When DVR source is selected and the Preview Window is in the Normal 30 or Maximized size, the system shall have the capability to control the DVR using the preview window portion 30 of the touch panel 10 as the touch panel for controlling the DVR destination. The DVR can be controlled to display the source video that is routed to the DVR for recording.

The system shall be capable of controlling the audio input recording by the DVR. Audio input controls shall be performed by controlling the specified audio processing device. For example, the DVR audio shall be capable of selecting any of the active configured audio sources as input to the DVR for recording. The playback of the audio recorded in the DVR shall be supported by the connection of an audio input to the DVR audio out. The playback of any DVR recording shall be controlled through the DVR's control menu.

The Observation Camera video is available as a video input in a video format. When the Observation Camera is selected as a source, the Observation Camera video can be viewed on the Preview Window 30, 36. The Observation Camera video can also be routed and viewed on a compatible display monitor. The non-compatible destinations shall be masked. The control of the Observation Camera shall not be available unless the Observation Camera Control is activated.

The Video Conference main screen video is available as a video input in a video format. When the Video Conference is selected as a source, the Video Conference main screen can be viewed on the Preview Window 30, 36. The Video Conference main screen can be routed and viewed on a compatible display monitor. The Video Conference destination shall be masked. The Video Conference source video cannot be routed back to the Video Conference destination.

The No Source Video Source Button 34 is configured to not have any video source associated with this button. When the No Source button 34 is selected, the Video Preview Window 30, 36 shall be blank with no video visible. Routing to any destination shall disconnect any video that may have been routed previously. The destination display selected shall be blank with no video visible.

The system shall be capable of controlling the video conference devices via the RS-232 Interface to perform the required video conference functions specified below.

The system can provide the capability to control Room Lighting settings. A Room Lighting Control Window (not shown) can be opened by selecting the Room Lighting button 42 when the Device Control Menu Window is visible. The Video Preview window shall be visible in the Reduced size Video Preview Window 36. The Room Lighting Control Window shall provide an exit button to close the control window to return to the main Video Routing mode. The Video Preview window shall return to the Normal size Video Preview Window 30.

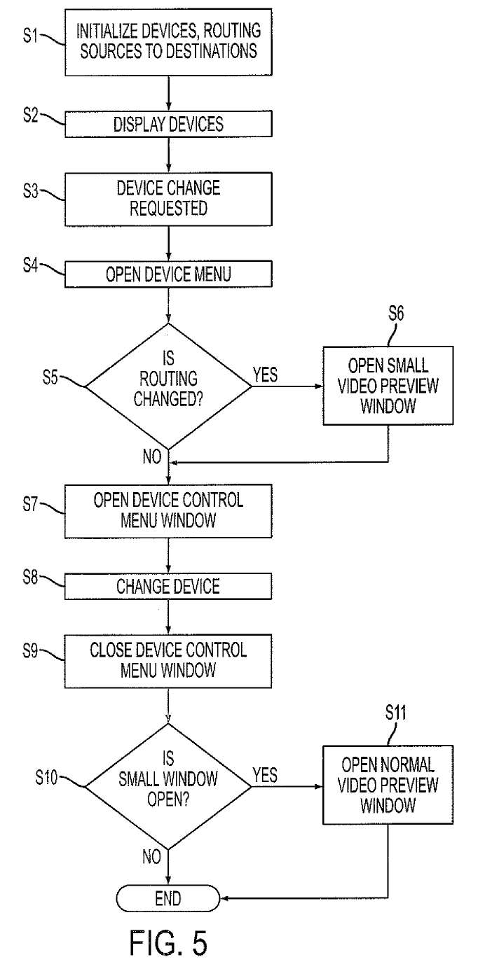

FIG. 5 is a flow diagram for the inventive system. Initially, in step S1, for each source, a destination is selected so that the source is routed to the selected destination. In step S2, a change is requested to a device. The Device Menu 16 is opened, by clicking or toggling, in step S3. Significantly, all of the devices on the touch screen 10 remain visible and operable. If a routing is to be changed (S4=YES), then the video preview window is reduced to Small Video Preview Window 36 in step S5. The device control window 38 for the device to be changed is opened in step S6. The change to the device, e.g., routing, increasing or decreasing lighting, etc., is made in step S7. The device control window 38 is closed or exited in step S8. If the Small Video Preview Window 36 is active (S9=YES), the normal-sized Video Preview Window 30 can be activated in step S10.

If there is no routing change (S4=NO), steps S6 to S8 are executed. As when a routing change is made (S4=YES), during the process when S4=NO, all of the devices on the touch screen 10 remain visible and operable.

An example of operation of the inventive system operates as follows. Note that this use case example is the same as that described above for currently known system, yet the outcome with the inventive system is advantageous. Initially, laparoscope camera video is routed to display 1, observation camera video is routed to display 2, and MRI image is routed on display 3.

During the procedure, the surgeon makes two consecutive requests, dim the room lights and route the laparoscope video to display 3. The user of the inventive system, a nurse in this example, responds to the surgeon's requests as follows. First, room light control is selected, causing display of the room light control sub-screen. However, video routing controls remain clearly visible with all of the established routes clearly identified. The user dims the room light and routes the laparoscope video to display 3 without changing the user interface screen. In other words, the user or nurse does not have to navigate through different screens to execute the required operations. Having the video routing controls available with all of the established routes clearly visible, while the control of room lights is executed, enables the nurse to remain focused on her specific tasks, dimming the lights and routing the laparoscope video display, and improves her ability to execute the video routing request quickly and accurately. Further this simplified process avoids the potential distraction and interruption to the ongoing surgical procedure.

The invention can be implemented as computer software or a computer readable program for operating on a computer. The computer program can be stored on computer readable medium, Various aspects of the present disclosure may be embodied as a program, software, or computer instructions embodied in a computer or machine usable or readable storage medium, which causes the computer or machine to perform the steps of the method when executed on the computer, processor, and/or machine.

System and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

While the present invention has been described in particular embodiments, it should be appreciated that the present invention should not be construed as limited by such embodiments, but rather construed according to the below claims.

What is claimed is:

1. A computer readable storage medium having computer readable program code used to direct a computer to optimize and prioritize video routing operations in conjunction with multiple integrated device controls in an integrated operating room system, said program code performing steps of:
initializing a routing having a source and a destination for one or more routable devices;
displaying on said integrated operating room system said routing and a device menu including said one or more routable devices and one or more non-routable devices;
requesting a change in one or more of said routable devices and said non-routable devices; and
for each of said devices for which the change is requested,
opening a device control window for said device using the device menu;
changing said device in accordance with the change request; and
closing said device control window;
wherein for every device for which a change is requested, when said device control window is opened, all other routable and non-routable devices remain accessible.

2. The program according to claim 1, wherein when a change is requested for a routable device, before the device control window for said device is opened, a video preview window is replaced with a small video preview window.

3. The program according to claim 2, wherein after the device control window is closed, the small video preview window is replaced with a normal video preview window.

4. The program according to claim 1, wherein displaying on said integrated operating room system is performed using a touch screen.

5. The program according to claim 1, wherein all other routable and non-routable devices remain accessible is performed by the all other routable and non-routable devices being visible on the touch screen.

6. A method for optimizing and prioritizing video routing operations in conjunction with multiple integrated device controls in an integrated operating room system, comprising steps of:
initializing a routing having a source and a destination for one or more routable devices;
displaying on said integrated operating room system said routing and a device menu including said one or more routable devices and one or more non-routable devices;
requesting a change in one or more of said routable devices and said non-routable devices; and
for each of said devices for which the change is requested,
opening a device control window for said device using the device menu;
changing said device in accordance with the change request; and
closing said device control window;
wherein for every device for which a change is requested, when said device control window is opened, all other routable and non-routable devices remain accessible.

7. The method according to claim 6, wherein when a change is requested for a routable device, before the device control window for said device is opened, a video preview window is replaced with a small video preview window.

8. The method according to claim 7, wherein after the device control window is closed, the small video preview window is replaced with a normal video preview window.

9. The method according to claim 6, wherein displaying on said integrated operating room system is performed using a touch screen.

10. The method according to claim 6, wherein all other routable and non-routable devices remain accessible is performed by the all other routable and non-routable devices being visible on the touch screen.

11. A system for optimizing and prioritizing video routing operations in conjunction with multiple integrated device controls in an integrated operating room system, comprising:
one or more routable devices, each having a routing having a source and a destination;
a display device displaying said routing and a device menu including said one or more routable devices and one or more non-routable device; and
a device control window openable by a device of said one or more devices when a change is requested,
wherein for every device for which a change is requested,
the device control window is opened for said device using the device menu,
said device is changed in accordance with the change request, and
the device control window is closed, and
when said device control window is opened, all other routable and non-routable devices remain accessible.

12. The system according to claim 11, wherein when a change is requested for a routable device, before the device control window for said device is opened, a video preview window is replaced with a small video preview window.

13. The system according to claim 12, wherein after the device control window is closed, the small video preview window is replaced with a normal video preview window.

14. The system according to claim 11, wherein the display device is a touch screen.

15. The system according to claim 11, wherein accessible means visible on the touch screen.
